(19) United States
(12) Patent Application Publication
(10) Pub. No.: US 2014/0162596 A1
(43) Pub. Date: Jun. 12, 2014

(54) DIGITAL CONTENT CARD

(71) Applicant: M. Sulthon A.I. Adchan, Jakarta Pusat. (ID)

(72) Inventor: M. Sulthon A.I. Adchan, Jakarta Pusat. (ID)

(21) Appl. No.: 14/103,018

(22) Filed: Dec. 11, 2013

(30) Foreign Application Priority Data
Dec. 11, 2012 (ID) P00201201148

(51) Int. Cl. H04W 4/24; H04W 4/18

(52) U.S. Cl. CPC H04W 4/24; H04W 4/18
USPC 455/406

(57) ABSTRACT

A Digital Content Card (DCC) is disclosed wherein the card contains a digital content for mobile phone users, which is marketed for public using various types of card and has a specific code as an identification of the type of offered content. Such cards contain various types of content with a content delivery system/method to mobile phone with different manners, which is in accordance with the type of content.

### TECHNICAL FIELD OF INVENTION

The present invention relates to a pre-payment card to purchase a content, more specifically with a method and system to purchase digital content from a digital content provider by using pre-payment digital content card.

### BACKGROUND OF INVENTION

Pre-payment cards have been introduced by retailers and service provides to allow consumers to purchase goods and services, amongst which without any pre-determined deposit or quantified during the purchase of the pre-payment card. For example, retailers may offer pre-payment gift card to a consumer to allow the card receiver to use the payment that bundled in the card to purchase products. In such case, that the balance in the pre-payment gift card is used for purchases.

Smart cards and user's identity module cards (SIM) combine implanted integrated circuit (IC) chip which is often used to control the access to the data inside the card. A card with a microprocessor is able to store information, conduct local processing on the data stored, and conduct complex calculations. These cards derived from credit card dimensions and brought in a form of contact card requiring card reader or “contactless” cards to use radio frequency signals to operate.

The SIM card and smart card applications that commonly known are: cellular phone card, credit card, electronic payment card, computer security system card, wireless communication card, satellite TV card, etc. These smart cards can be utilized with deploying smart card reader onto a computer to authenticate a user. A Web browser may also use the smart card technology to equip Secure a Sockets Layer (SSL) for enhanced security of internet transactions.

US patent application No. US 2005/0067483 A1, published on 31 Mar. 2005 disclosed a method and system to provide digital content for consumers by using a pre-payment digital content medium. The method and system include receiving specific identification information that is combined with a pre-payment digital content medium (PDCM) from a PDCM consumer distributor. When a payment for PDCM is made by a user, the identifying information that is combined with the PDCM will be sent to authentication service provider, and PDCM will be activated based on the said identifying information. The authentication service provider will send an activation confirmation from the PDCM to the digital content provider as a response to the confirmation request from the digital content provider. Specifically, the digital content provider will send a request to confirm as a response to the request for digital content by a consumer who owns a purchased PDCM.

U.S. Pat. No. 8,172,138 B2, granted on 8 May 2012, discloses a device with the purpose of providing a secure payment similar to the certification of digital content access, comprising of at least one integrated circuit (IC) containing an operating system such as: providing memory, which is interconnected with an interface from a number of layered electric input contact, and at least one device to encode the previously described series for use in the layered electric contact, and at least one encoding mathematic formula is stored on a IC chip to generate access code to be adjusted with the previously described access code. Within the scope of this invention, the previously described series is preferably planted in an analog format on a plastic card in which the IC chip is embedded. The previously described series is more preferably encoded in a magnetic strip of the plastic card in which the IC chip is implanted.

U.S. Pat. No. 7,016,496 B2, granted on 21 Mar. 2006 provides a system and method for delivering digital media contents to user over a network. The relevant patent allows various types of electronic devices to access the same digital media content for the same end user through the use of a smart card equipped with a license for the said digital content media. Depending on the format of digital media contents, devices such as cellular phone, pager, PDA, etc., may be used to present the digital media content to the users.

### SUMMARY OF INVENTION

A Digital Content Card (DCC) according to the present invention is a card containing digital content which is purposed for mobile phone users or for products using an ARM processor, such as: tablet PC and ARM processor-based smart box. It is available for public using various types of cards and bear specific code as the identification of the type of offered content. Such cards represent numerous types of content with a content delivery system/method to a mobile phone or products using the ARM processor such as: tablet PC and ARM processor-based smart box with different manners based on the content type.

Digital content card (DCC) according to this invention is different with any voucher cards used to sell games content or top-up for mobile phone number and e-wallet. The digital content card (DCC) according to this invention has a wide variety of content types, including:

### 1. Music Content (Digital Album Card (DMC)—Souniq®).

Digital album card for music is a DCC type for a song album containing 10-12 songs or more from a particular artist or a compilation of songs from various artists. This content can be downloaded byway of accessing a website (R9)/wap site (R9) address of the song content and inputting a code displayed on the DCC. The code preferably is barcode, QR Code and/or NFC. This technology allows DCC content to be downloaded through a scanner camera for QR-code (R7) and Barcode, or through Wireless NFC available in a mobile phone or any products using ARM processor such as: tablet PC and ARM processor-based smart box. Customer is no longer required to manually open the website (R9) site (R9) or to input any code numbers displayed on she DCC. The NFC technology allows downloading a music content simply by bringing the DCC closer, she customer would then be able to easily to download all songs according to songs album bought into she customer's mobile phone or any products using ARM processor such as: tablet PC and ARM processor-based smart box. The customer may further instantly listen to the relevant songs through his/her mobile phone. The said digital album card is also equipped with an Apps software product for a mobile phone or products using ARM processor such as: tablet PC and ARM processor-based smart box, thus it would not be necessary for customers to access a web or wap, but may simply play the Apps player available in the customer's mobile phone.

### 2. Book Content (Digital Book Card (DBC)—Folds®)

Digital Book Card (DBC) is created for digital content books containing material that is identical with hardcopy version of the book or with a digital book that summarizes the original book. This is created for people with the desire to read books yet does not have the sufficient time to do so. As such, it will be sufficient for them to read a summary of the book through mobile phone or products using ARM processor such as: tablet PC and ARM processor-based smart box. The Digital Book Card is also equipped with an application (Apps) for all of the available operating system (OS) for mobile phone/Tabs/IPAD. A customer can instantly enjoy the book application through his/her gadget through activation by way of inputting the numerical codes displayed in the digital book card, or by scanning technology of QR-code (R7)/Barcode (R5) and Wireless NFC. A customer may enjoy the book content in part within a pre-determined duration, e.g. daily, so the customer may read it every day. For a digital content that has identical content as the original book (not a summary), the book material can be downloaded based on book chapters. This is to enable customers to download in smaller size.

### 3. Educational Content (Digital Educational Card/Digital Edu Card (DEC) Oghma®)

Digital Edu Card (DEC) is a digital product for educational/education content provided for customers to receive the educational content through online and interactive streaming so that the education process can be conducted in a more interesting approach. This product is usually designated for students or early-age children, with the material in line with their current lessons. As such, the educational process outside the school can be conducted at any places with a simpler and in a more interactive manner.

The DEC is equipped with Apps for all available operating system for mobile phone/Tabs/iPAD. A customer can instantly read the educational content through his/her gadget, by simply conducting activation by inputting the numerical codes displayed in the digital catalogue card, or by QR-code (R7)/Barcode (R5) scanning technology and Wireless NFC.

### 4. Movie Content (Digital Movie Card (DMC)TIVIKU).

Digital Movie Card (DEC) is a digital product for movie content that is sold in retail through online streaming system. The customers would be able to watch favorite movies at anytime and anywhere as long as the internet interconnection with certain wideband is available. The DMC has an expiry date in accordance with the period stated on the relevant DMC. The DMC is similar with a movie rental card, which allows customers watch movies in mobile phone, tablet computer (Tabs), iPAD, or Smart TV that supports the DMC service. The DMC is equipped with Apps for all platforms either smartphones, tablets, iPAD and android-base smart box TV.

### DESCRIPTION OF FIGURES

For the purpose of understanding the present invention and further understand how the invention is implemented in practice, a number of embodiments are hereby described, making reference to attached figures, whereby;

FIG. 1 illustrates a detailed view of a smart card that is implanted with an IC chip from the prior art.

FIG. 2 illustrates a block diagram describing network scope according to the prior art.

FIG. 3A illustrates the front side and backside views of a digital content card that use a barcode (R5) according to the present invention.

FIG. 3B illustrates the front side and backside views of a digital content card.

FIG. 4 illustrates the content delivery process of a digital card according to the present invention.

### DETAILED DESCRIPTION PREFERRED EMBODIMENTS

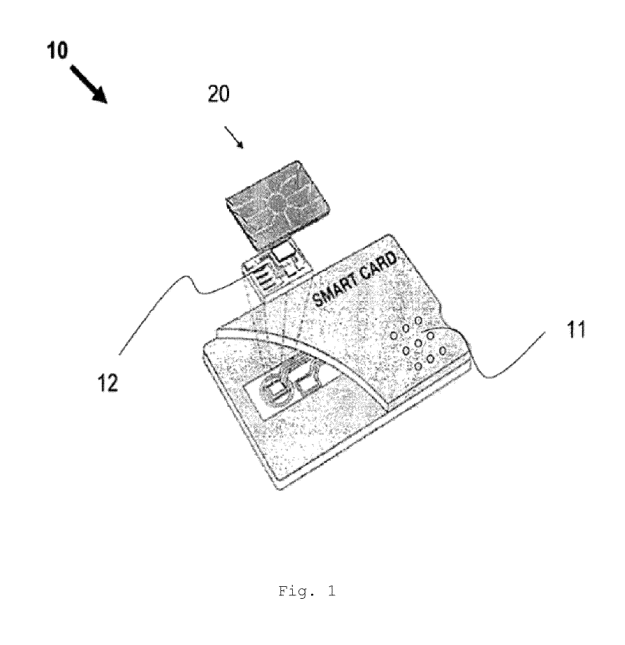

FIG. 1 illustrates the smart card that is implanted with an IC chip (12) in detail. The access to the IC chip content is limited by a series of electric signals to be used on a contact plate (20) by a card reader (not shown) and is obtained from an implanted analog encoding (11). The card reader (not shown) compares the series of electrical input or alternatively the responses that had been coded to the series produced by the IC chip (12) with a digital statement that it Was obtained from an analog encoding (11). If it is not compatible, the card reader will instruct the IC chip with the facility from the electrical input series on the plate (20) to inactivate the card.

The term ‘smart card’ further refers to plastic cards in the form of credit card which is implanted with the integrated electric circuit to allow storage of information, operating local processing on the data stored, and also perform a complex calculation. The term ‘IC Chip’ refers to an integrated circuit that is specifically implanted into a plastic card with the capacity to receive, process and postpone data, as eventually to keep data for final reception.

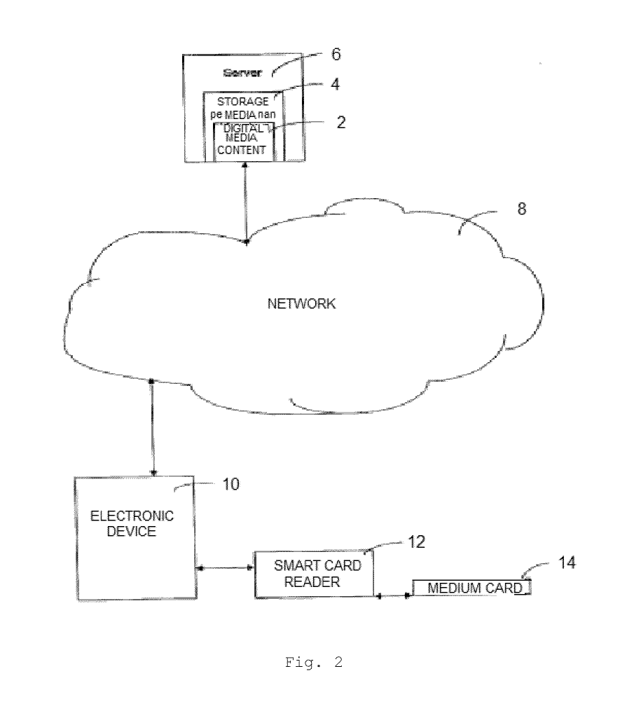

FIG. 2 shows a network environment according to the prior art. In the said figure, the digital content media (2) is stored in a storage media (4). The storage media (4) is located in a server (6) (6) interfaced with a network (8) or other communication networks, such as: wireless networks, computer networks, etc. An electronic device (10) with network interface is connected to a network (8) and to a smart card reader (12). The smart card reader (12) contains an inlet to insert a media card (14). A person skilled in this art will understand that there are a number of possible network configurations that may be utilized in this art.

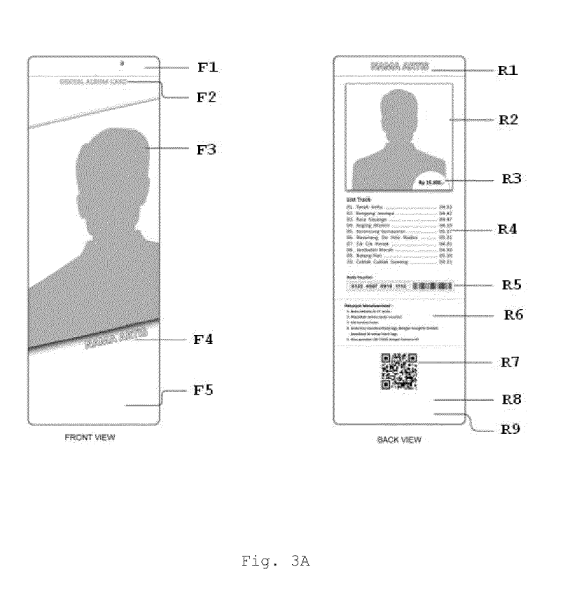

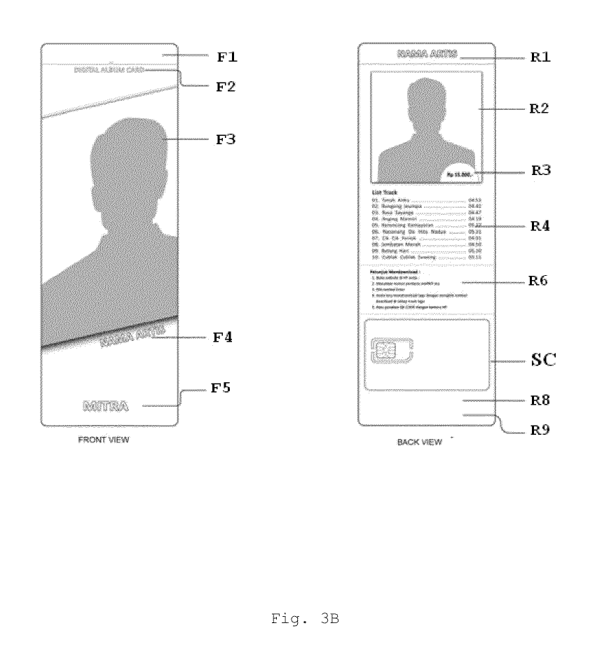

FIG. 3A and FIG. 3B illustrate the physical form of a digital content card according to the present invention that is bundled with a mobile phone SIM card starter pack according to the present invention. This product is sold by way of bundling with a SIM card operator. The manner to access the digital content refers to the same manner as illustrated in FIG. 3A.

The present invention is aimed to provide a bundling selling method with a SIM card package telecommunication operator.

The types of digital content cards according to the present invention are divided into two types:

a. A digital content card without a SIM card (SC).
b. a digital content card with a SIM card (SC) (bundled by a SIM card operator)
The digital content card consists of;

On the front side:
brand name (F1)
brand digital video card (F2)
image visual product (F3)
name of artist (F4)
name of partner (F5)
product visual, image (F6)

on the back side:
name of artist (R1)
image visual, product (R2)
product price (R3)
description of product (song list) (R4)
barcode (R5)
download instruction (R6)
QR-code (R7)
brand name (R8)
site (R9)
   The parts of said card are intended as follow. Brand name (F1, R8) is a brand of the card. Brand digital video card (F2) is a brand of the card producer. Image visual product (F3, R2) is an image of product representation. Name of artist (F4, R1) is the artist or performer of songs. Name of partner (F5) is the name of producer. Product price (R3) is price of the content released by producer. Description of product (song list) (R4) is information what songs contained in that card. Barcode (R5) is code of voucher in form of barcode, to download songs. Download instruction (R6) informs how to download the listed songs. QR-code (R7) is code of card in form of 2D code. Site (R9) informs website user may contact for further interaction. Those displays are information regarding content of the card.

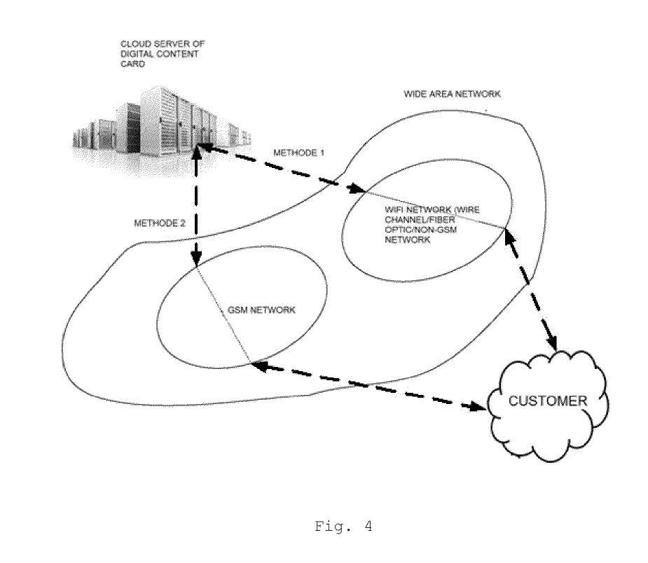

FIG. 4 illustrates a content delivering process of a digital card according to the present invention. The delivery process of the Digital Content Card (DCC) from Server (6) Cloud owned by DCC to being properly sent to the customer's gadget is as follows;

a. all contents of the DCC, either in the form of music, book, education, and movies content, are present in the DCC server,
b. a customer uses WAR (a web through a cellular phone) and Apps DCC (music, book, education, and :movie) to access the DCC server (6) by using two methods of connection:
interconnection with a GSM network provided by a telecommunication operator. This connection usually incurs charges according to each telecommunication operator tariff. The applicable interconnection tariff through a GSM telecommunication operator no included from the DCC selling price,
interconnection by using a WIFI connection provided by an Internet Service Provider (ISP). This type connection may incur charges and may not incur charges, i.e. through a WIFI connection.
   c. each interconnection will connect the WAP & Apps mobile to a DCC server (6) so that the purchased content may be downloaded or played online (streaming) through the relevant mobile player Apps.
   d. The hierarchy of the content delivery is as follows:
The customer opens WAP or Apps Mobile phone,
The WAP or Apps is connected with a server (6) through GSM/3G network or WIFI connection,
The customer inputs a number code (Barcode (R5), QR Code (R7), and/or NFC) displayed on the DCC according to available column in said WAP or Apps Mobilephone, either manually or using a code reader,
The WAP or Apps performs a download request according to the purchased DCC content,
The server (6) sends a content according to request from WAP or Apps Mobile phone,
The customer can play the downloaded content through the Mobile phone Apps o native player according to the DCC digital file content format.
   While the example embodiments are being specifically described by referring to the figures, it will be understood by a person skilled in this art that a number of changes on the forms and details can be made without deviating from substance and scope of inventive concept as claimed by the appended claims. The example embodiments should be considered only for explanation purposes and are not intended to limit the scope of invention. Accordingly, the scope of the present invention is not determined by a detailed description from the example embodiments, but by the attached claims, and the whole differences within this scope of invention will be explained as if they fall within the scope of this invention.

1. A Digital Content Card (DCC) delivery system comprising of:
interconnection with a GSM network provided a telecommunication operator. This connection usually incur charges according so each of the telecommunication operator tariff,
interconnection using WIFI connection provided by an Internet Service Provider (ISP).

2. A content delivery system according to claim 1, whereby each interconnection will connect the WAP & mobile Apps to a server (6) digital content card server (6) so that the purchased content can be downloaded or played online (streaming) through the mobile Apps player or by offline that does not require any connection to the digital card server (6) because the content has been stored in a mobile handset.

3. A content delivery system according to claim 1, which consists of the following steps:
A customer opens WAP or Mobile phone Apps. The WAP or Apps is connected with a server (6) through a GSM/3G or WIFI network,
The customer inputs a number code (Barcode (R5), QRCode (R7), and/or NFC) displayed on the DCC according to available column in said WAP or Apps Mobilephone, either manually or using a code reader,
The WAP or Apps performs a download request according to the purchased DCC content,
The server (6) sends the content according to request of the WAP or Mobile phone Apps,
The customer can play the downloaded content through the Mobile phone. Apps or native player which is compatible with the to DCC digital content file format.

4. A content delivery system according to claim 1, in which content consists of music, books, education, and movie contents are stored in a server (6) digital content card server.

5. A digital content card according to claim 1, wherein the back side of the card displays a QR code or SIM card.

6. A digital content card according to claim 1, whereby the digital content card has been implanted with a circuit in the inner layer of the card that functions as an NFC device.
